(19) United States
(12) Patent Application Publication
(10) Pub. No.: US 2009/0074624 A1
(43) Pub. Date: Mar. 19, 2009

(54) LIQUID TRANSFER DEVICE

(76) Inventor: Don Liang, Jhongli (TW)

Correspondence Address: KIRTON AND MCCONKIE, 60 EAST SOUTH TEMPLE,, SUITE 1800, SALT LAKE CITY, UT, 84111, US

(21) Appl. No.: 12/124,738

(22) Filed: May 21, 2008

(30) Foreign Application Priority Data
Sep. 19, 2007 (TW) 096215747

(51) Int. Cl. B01L 3/02; B01L 3/00

(52) U.S. Cl. 422/100; 422/102

(57) ABSTRACT

A liquid transfer device is provided for biochemical assay, including a pipette forming an interior space extending in an axial direction and having first and second ends. The first end forms an opening and the second end forms an enclosed variable volume, whereby variation of the volume causes a change of pressure to selectively induce a suction force and a releasing force in the pipette. An analysis container includes a plurality of receptacles retained by a slab. A film covers the slab to seal the container. A movement control device includes a manipulator that releasably holds the pipette and a tray that forms a cavity for receiving and retaining the container. The pipette and the tray are movable with respect to each other in order to fill/draw test agent into/out of the receptacles.

### BACKGROUND OF THE INVENTION

1. Field of the Invention

The present invention relates to a liquid transfer device, and in particular to an automatic tiny-amount liquid transfer device in which a pipette works with a multiple-receptacle analysis container that is pre-filled with test agent to carry out operations of purification, extraction, separation and selection on nucleic acids.

2. The Related Arts

With the advancement of researches on human genome and functional group, research/developing techniques for macromolecular biology of life science, such as nucleic acids, proteins, and enzymes, is getting mature. However, biochemical samples are often mixtures of various components and having extremely complicated compositions. Heretofore, biochemical samples, such as blood and cells, are first purified by means of separation, extraction, and heating and then inspection and selection of the purified samples are conducted.

Purification of nucleic acids is mature technique and a standardized process for sample purification includes loading the sample into a container and adding a buffer solution in the container, followed by disposing magnetic beads into the container and mixing the magnetic beads with the sample and the buffer solution in the container to thereafter proceed with magnetic separation. Then, an elution buffer is added and the sample is heated. Finally, extraction of purified products is carried out. Due to the standardization of the process of purification, mass production of test agents can be readily done for regents for the purification of different nucleic acids. Three major issues are currently concerned for the conventional purification techniques. The first issue is to effect precise control of the amount of test agent that is sucked, released and transferred with a conventional liquid transfer pipette. The conventional liquid transfer facility uses a piston inside the pipette that change positions to induce a pressure difference between inside and outside the pipette. To temporarily hold an amount of liquid for realizing suction, transfer, and mixture of the test agents, a tip is needed. A drawback of the repeatedly usable piston-based tip is concerned with cross contamination occurring in the course of liquid transfer among different samples. Further, the tip that is used with a liquid transfer pipette requires piston rings that need regular and periodic replacement and maintenance. In addition, the conventional device is made complicated in order to realize precise control of the amount of liquid transferred by using the piston-based tip working with the liquid transfer pipette, and the operation gets very inconvenient. Costs of time and labor have extensively wasted, making it is necessary to improve the conventional device. Secondly, in magnetic separation that is included in the purification of nucleic acids, conventionally, a hollow sheath is used to receive a magnetic member therein and the hollow sheath with the magnetic member therein is extended into a test agent container that is pre-filled with a test agent to carry out the magnetic separation. This method suffers that only a limited number of magnetic beads can be removed from the test agent container each time the sheath is inserted into the container. Thus, the sheath must be repeatedly reached into the container to carry out magnetic separation until desired extraction sample is obtained. Such a magnetic separation process is very troublesome and needs extra time and handling, making it necessary to improve. Further, a film is attached to and seals the agent container to protect the agent from contamination. In order to facilitate removal of the film, the film, which is usually made of plastics, is not so securely attached to the container, often leading to leakage of the agent, which can be volatile, out of the container once variation of pressures takes place, or simply due to defeat sealing of the film. On the other hand, in some cases, the film might get too secured to the container, making the removal extremely difficult and eventually leading to undesired spillage of the agent in removing the film with excessive force.

It is noted that Korean Patent KR10-0445560 (Publication number: KR20030035621/Publication date: 2003 May 9) discloses a nucleic acid separation kit, which comprises a cylindrical container and a dome cover, which are separate parts. The container forms therein a plurality of cells. The cover forms inward projections. The inside diameter of the container defines a space for accommodating the insertion of a magnetic bar for carrying out magnetic separation that is a necessary step for purification of nucleic acids. The cells, after being filled with buffer liquids or enzymes, are sealed with a film. To carry out purification of nucleic acids, the projections of the cover pierce through and break the film that seals the cells. This operation, however, suffers a drawback that the surface of the film that seals the cells is very likely to have contaminants that might significantly deteriorate the result of the purification process attached thereto, especially after the device has been subjected to transportation or conveyance. In addition, the handling process of transportation and disassembly may also cause potential risk of attaching human or animal skin, blood, sweat to the surface of the film so that when the projections of the cover piece through the film and get into the cells, the contaminants entrain the projections into the cells, making the purification of the final products deteriorated.

Apparently, all the known liquid transfer devices suffer drawback and disadvantages. Improvement is needed to provide a liquid transfer device that eliminates cross contamination caused by the operation of a liquid transfer pipette, while ensures easy removal of the sealing film to avoid contamination and deterioration of the result of inspection caused by surface contaminants of the film to thereby overcome the drawbacks of the know techniques.

### SUMMARY OF THE INVENTION

An objective of the present invention is to provide a liquid transfer device and an analysis container for use with the liquid transfer device, which provides precise control of the amount of test agent inside a pipette used in the liquid transfer device and also ensures proper isolation between samples and the surrounding to eliminate the potential risk of cross contamination in the course of biochemical purification, extraction, selection, and inspection.

To achieve the above objective, according to the present invention, a liquid transfer device comprises a pipette, an analysis container, cover means, and a movement control device. The pipette forms an interior space extending in an axial direction and having first and second ends. The first end forms an opening. The second end forms an enclosed variable volume and variation of the volume causes change of pressure, which selectively induces a suction force or a releasing force in the pipette. The pipette further comprises at least one fixing section. The analysis container forms a plurality of receptacles which is retained by a slab and is pre-filled with test agents that are required for the processes of biochemical operation. The analysis container comprises a lock section. The cover means comprises a cover film that covers a surface of the slab to seal the analysis container after the receptacles are filled with the test agents. The movement control device comprises a manipulator and a tray. The tray forms a cavity for receiving the analysis container therein and a retention section engageable with the lock section to secure the analysis container to the tray.

To achieve the above objective, the present invention also provides a pipette for use in a liquid transfer device. The pipette comprises a hollow member extending in an axial direction and having first and second ends in the axial direction. The first end forms an opening and the second end forms an enclosed variable volume. The variation of the volume causes change of pressure to selectively induce a suction force or a releasing force in the pipette. The pipette also comprises at least one fixing section for being held by the liquid transfer device.

To achieve the above objective, the present invention provides an analysis container for use in a liquid transfer device. The analysis container comprises a plurality of receptacles retained by a slab. Among the receptacles, one is a magnetic separation receptacle, which has a specific configuration, disposed at an end of the slab. The magnetic separation receptacle has a flat bottom having a sloped surface to cooperate with a magnetic element for carrying out magnetic separation operation. In other words, the magnetic element is positioned close to the sloped surface of the magnetic separation receptacle to magnetically attract magnetic beads received in the receptacle to the sloped surface whereby a pipette can be deeply inserted into the receptacle to draw in test agent after the magnetic separation. With the magnetic beads held on the sloped surface, the pipette can be moved to locate above the sloped surface for releasing test agent stored therein and then moved to the bottom of the receptacle for re-draw in the test agent. By repeatedly flushing the magnetic beads held on the sloped surface in this way, extraction sample of high purity can be obtained.

The analysis container further comprises a lock section. And cover means comprising a film is provided for covering a surface of the slab. The receptacles of the analysis container are pre-filled with test agents that are required for carrying out biochemical operations. The film covers the surface of the slab after the receptacles are filled with the test agents to seal the receptacles. The slab forms an opening in which an individual receptacle is received and retained. The individual receptacle comprises a cover and functions as a final product collection receptacle and is located at an end of the slab. The slab has a surface on which a tip portion is formed at a location close to the opening for the final product collection receptacle. The tip portion forms a step that defines a difference in altitude with respect to the surface of the slab. After the receptacles are filled with required buffer liquids or test agents, the films covers the surface of the slab and the tip portion to completely seal the receptacles. With the arrangement of the tip portion, the removal of the film is made easy.

Compared to the prior art techniques, the present invention provides a liquid transfer device and a pipette and an analysis container used in the liquid transfer device, wherein the pipette is a disposable tube having a sealed interior space that effectively alleviate cross contamination occurring in the course of liquid transfer. Further, the manufacturing of the disposable tube of the pipette overcomes the complicated process that is conventional adopted, but still maintaining the precision of the amount of the liquid being transferred. The present invention also provides an analysis container that is pre-fillable with biochemical agents and a tray, both being engageable with and thus retained to each other. Further, a tip portion is provided on the analysis container to facilitate removal of a cover film that seals the container to thereby eliminating any potential risk of deterioration of the result of purification, extraction, selection, and/or inspection of nucleic acids due to contamination of the test agents inside the container caused by contaminants attached to the surface of the cover film.

It is to be understood that both the foregoing general description and the following detailed description of the present invention are exemplary and explanatory and are intended to provide a few optimal embodiments and descriptions in details in conjunction with the accompanying drawings, in which:

### BRIEF DESCRIPTION OF THE DRAWINGS

FIG. 1 is a front elevation of a liquid transfer device constructed in accordance with the present invention;

FIG. 2 is a side elevation of the liquid transfer device of the present invention;

FIG. 3 is a side elevation illustrating the operation of the liquid transfer device in accordance with the present invention;

FIG. 4 is also a side elevation illustrating the operation of the liquid transfer device in accordance with the present invention;

FIG. 5A is a top view of an analysis container according to the present invention;

FIG. 5B is a cross-section view of the analysis container according to the present invention;

FIGS. 6A and 6B are perspective views respectively showing a cover film detached from the analysis container and the cover film attached to the analysis container;

FIGS. 7A and 7B are cross-sectional views showing the operation of mounting the analysis container to a tray in accordance with the present invention; and

FIG. 8 is a perspective view illustrating the operation of the liquid transfer device in accordance with the present invention.

### DETAILED DESCRIPTION OF THE PREFERRED EMBODIMENT

The present invention will now be described more specifically with reference to the following embodiments. It is to be noted that the following description of the preferred embodiments of the present invention is presented for purpose of illustration and description only and it is not intended to be exhaustive or to be limited to the precise forms disclosed.

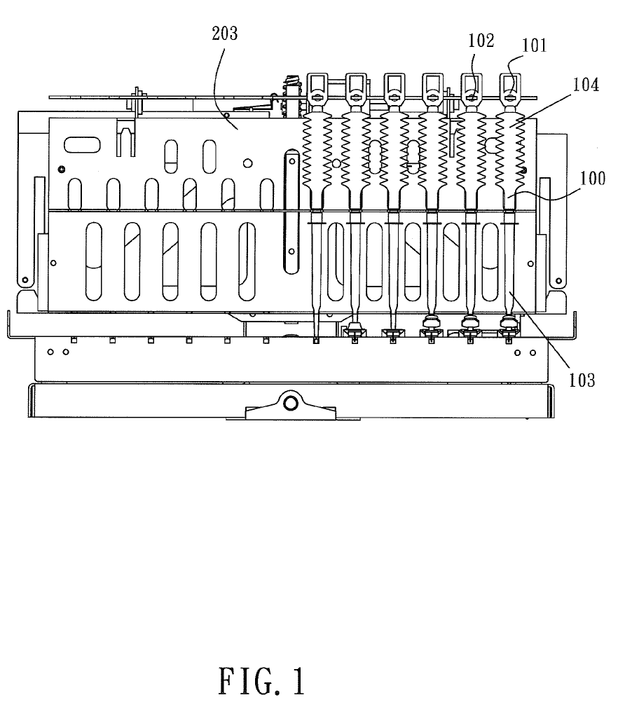

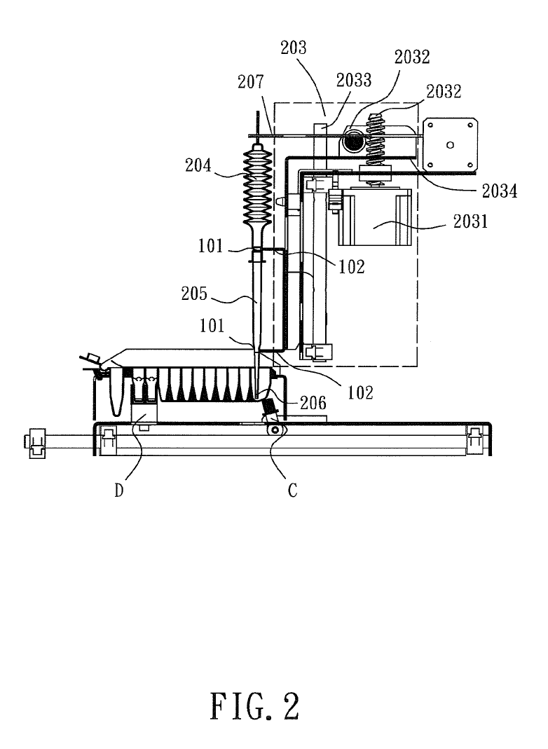

With reference to the drawings and in particular to FIGS. 1 and 2, a liquid transfer device constructed in accordance with the present invention is show, comprises a pipette 100, which comprise an elongate hollow member that extends in an axial direction and is integrally formed or formed by combination of two or more separate components. The pipette 100 has a first end 103 and a second end 104. The second end 104 of the pipette 100 comprises a fixing section 101 with which the pipette 100 is securable to a coupling member 102 of a manipulator 203. The manipulator 203 comprises a motor 2031, a transmission component 2032, a transmission shaft 2033, a panel 2034 (see FIG. 2). The manipulator 203 comprises at least one coupling members 102, and preferably the manipulator 203 comprises a plurality of coupling members 102, such as two as best seen in FIG. 2, and corresponding to each of the plurality of coupling members 102, the pipette 100 is provided with a fixing section 101, such as a groove, a circumferential slot, or a hole, engageable with the coupling member 102 for example in an interference fitting manner to thereby mount the pipette 100 to the manipulator 203 in a radial direction. The liquid transfer device of the present invention allows for mounting and/or dismounting in a horizontal direction to reduce potential risk of cross contamination during the process of mounting/dismounting of the pipette 100. However, this is only one illustrative, not limitative, example for mounting the pipette 100 and the present invention is not limited to such an example. In addition, the coupling members 102 also function to limit or set the position and vertical level that the pipette 100 is mounted to the manipulator 203.

The first end 103 of the pipette 100 forms an opening or nozzle 206 and the second end 104 forms an enclosed volume-variable bladder 204, whereby variation of the volume of the bladder 204 causes difference in pressure, which selectively induces a suction force and/or a discharge force. Preferably, the volume-variable bladder 204 comprises a bellow structure made of an elastic material, which has a resilient property facilitating re-expanding a compressed volume of the bladder 204 that is caused by an externally applied collapsing force. The bladder 204 is constructed to extend in an axial direction of the pipette 100 or in a direction transverse to the axial direction or the bladder 204 can be an elastic structure assuming a spherical shape. It is noted that the specific configuration of the bladder 204 illustrated in the drawings is just a non-exhaustive example, and is not considered a limitation to the scope of the present invention. The pipette 100 is preferably made by plastic injection molding and the material that makes the pipette 100 can be selected from a group consisting of polycarbonate, polypropylene, polyethylene, and polystyrene. Further, the molded pipette 100 is constructed that the pipette 100 comprises a storage chamber 205 formed between the opening 206 of the second end 104 and the bladder 204 of the first end 103 to serve as a storage space for suction, transfer, and mixing of test agents during processes of purification, extraction, selection, and inspection.

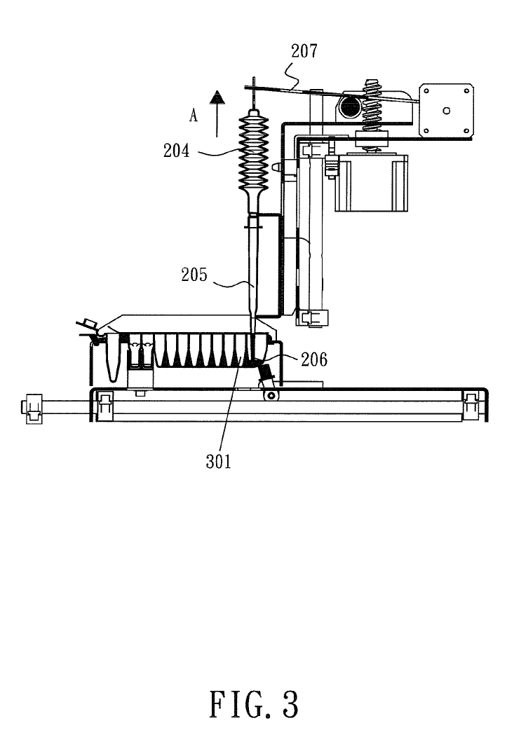

FIG. 3 demonstrates the operation of the liquid transfer device in accordance with the present invention. A driving mechanism 207 is provided for generating an action force to the bladder 204 of the pipette 100 to cause variation of volume of the bladder 204, which in turn generates a pressure difference that realizes suction and/or discharge of test agents. Particularly, the driving mechanism 207 may generate an upward action force A, which expands the volume of the volume-variable bladder 204, so that a suction force is induced in the pipette 100, which draws liquid sample or agent that is pre-filled in a receptacle 301a into the storage chamber 205 of the pipette 100 via the opening 206. With the movement of the manipulator 203 (see FIG. 2) along a given direction, the liquid sample or agents held in the storage chamber 205 is moveable to a next receptacle 301 to carry out purification, extraction, selection, and/or inspection of nucleic acids.

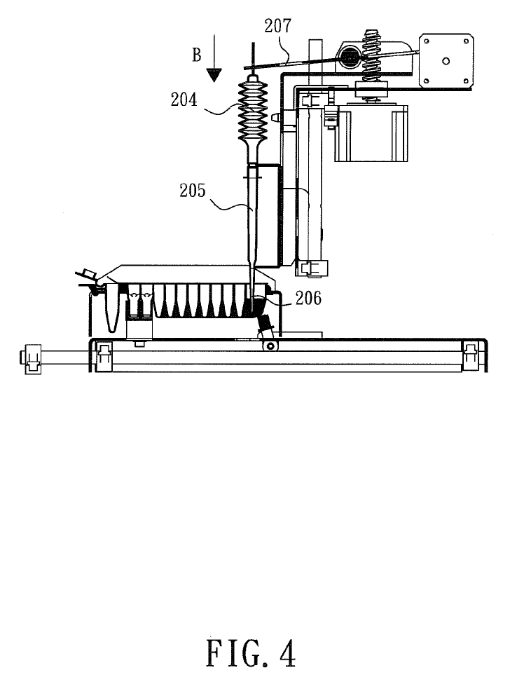

As shown in FIG. 4, the driving mechanism 207 is also operable to generate a downward action force B to the pipette 100 to compress the volume of the volume-variable bladder 204. Thus, a releasing force is induced in the pipette 100 to release or discharge the liquid sample held in the storage chamber 205 for mixing with the liquid or agent that is pre-filled in the receptacle 301a. In other words, the driving mechanism 207 is reciprocally operable to selectively generate the upward action force A or the downward action force B, either of which varies the volume of the volume-variable bladder 204. By this, the volume of the bladder 204 can be straightforward varied and the restoration or resumption of the bladder 204 can be maintained consistent. It is noted that the present invention is not limited to using the described driving mechanism 207 to act on the bladder 204 for suction and/or discharge or release of a liquid sample into/out of the pipette 100 and it is apparent that various combination and assembly or construction can be employed in accordance with practical requirements to cause volume variation of the bladder 204 and thus pressure difference for suction/release of liquid sample into/out of the pipette 100.

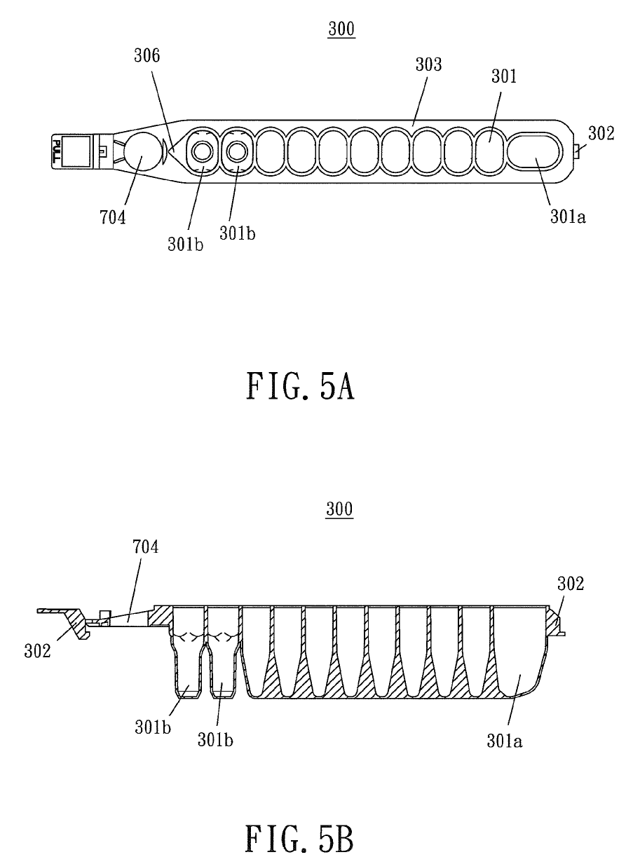

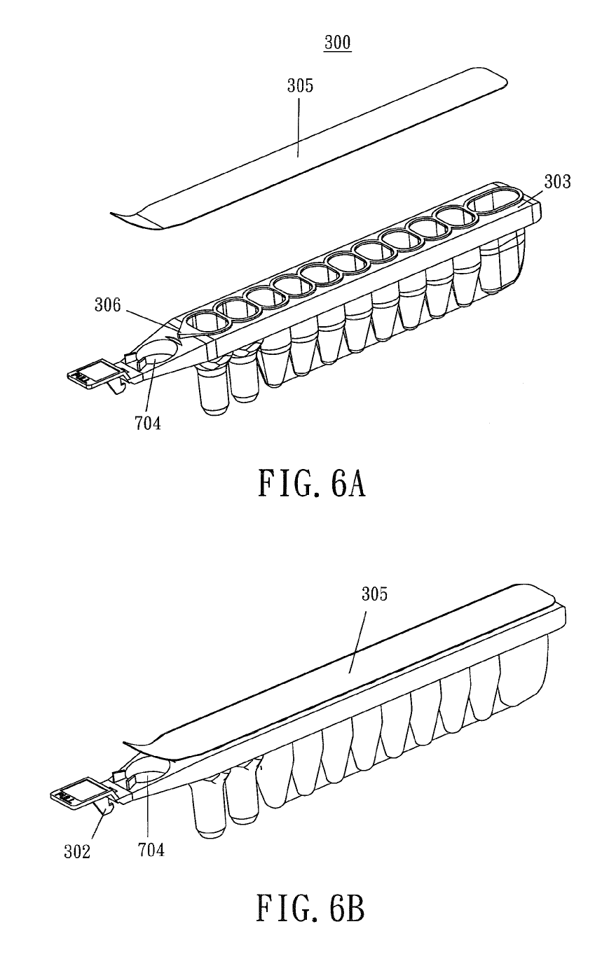

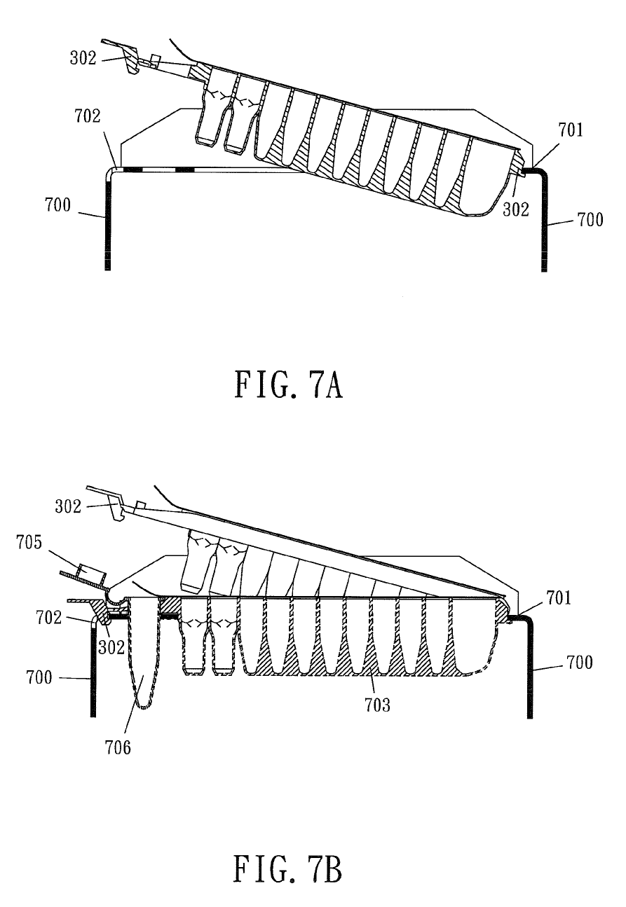

Referring to FIGS. 5A, 5B, 6A, 6B, 7A, and 7B, the liquid transfer device in accordance with the present invention further comprises an analysis container 300 forming a plurality of receptacle 301, 301a, 301b which is retained by a slab 303 and functions to contain therein test agents for processes of biochemical purification, extraction, selection, and inspection. The slab 303 also forms an opening 704 for receiving and holding an individual receptacle 706 that functions as a final product collection receptacle which is located at an end of the slab 303. The individual receptacle 706 is provided with a cover 705. The receptacles of the analysis container 300 include a magnetic separation receptacle 301a having a specific configuration that includes a substantially flat bottom having a sloped surface for carrying out magnetic separation operation with a magnetic element C (see FIG. 2) by positioning the magnetic element close to the sloped surface of the magnetic separation receptacle 301 so as to attract and hold magnetic beads (not shown), which are disposed into the magnetic separation receptacle 301, on the sloped surface, whereby the pipette 100 can be fed deeply into the magnetic separation receptacle 301 to draw in the test agent that has been subjected to magnetic separation process and further the pipette 100 can be moved to locate above the sloped surface and release or discharge the test agent that is held in the storage chamber 205 thereof onto the magnetic beads and then draw in the test agent again, leading to repeated flushing of the magnetic beads to thereby obtain a highly purified extraction sample. The receptacles of the analysis container 300 also include temperature-controlled receptacles 301b, which are positioned in association with a temperature control element D (see FIG. 2) for realizing temperature control that maintains the optimum temperature range desired for certain processes.

The analysis container 300 in accordance with the present invention can be filled in with test agents and/or buffer liquids for biochemical purification, extraction, selection or inspection and a cover film 305 is provided for covering a surface of the slab 303 to seal the analysis container 300. The analysis container 300 forms a tip portion 306 on the surface of the slab 303 at a location close to the opening 704, in which the individual receptacle 706 is received and held. The tip portion 306 is set in the form of a step or a shoulder that defines a difference in altitude with respect to the surface of the slab 303 so as to facilitate and ease the removal of the cover film 305 off the surface of the slab 303.

The analysis container 300 further comprises a lock section 302 formed at each one of opposite ends thereof. It is noted that the location and number of the lock sections 302 are not considered as limitation to the scope of the present invention, and it is preferred that two lock sections 302 are respectively provided at the opposite ends of the analysis container 300 for simplification of manufacturing. The lock sections 302 are engageable with a tray 300 that forms at least one cavity 703 so that the tray 700 carries the analysis container 300. In this respect, the lock sections can of different forms, as long as they are engageable with counterpart retention sections formed on the tray 700 to secure the analysis container 300 to the tray 700. The tray 700 forms retention sections 701, 702 corresponding to and engageable with the lock sections of the analysis container 300 to secure the analysis container 300 to the tray 700. Once the analysis container 300 is so secured to the tray 700, the cover film 305 can be removed from the slab 303 with the aid of the tip portion 306. In this way, deterioration of final extraction due to pollution/contamination of the test agents contained in the container 300 caused by any contaminants attached to the surface of the cover film 305 can be eliminated. The cover film 305 also provides tight sealing that prevents volatile liquid contained inside the container 300 from evaporation and loss. The cover film 305 can be attached to the slab 303 by ultrasonic processing or thermal fusion to realize the tight sealing. The container 300 can be made of for example polycarbonate, polypropylene, polyethylene, polystyrene, and styrene copolymer.

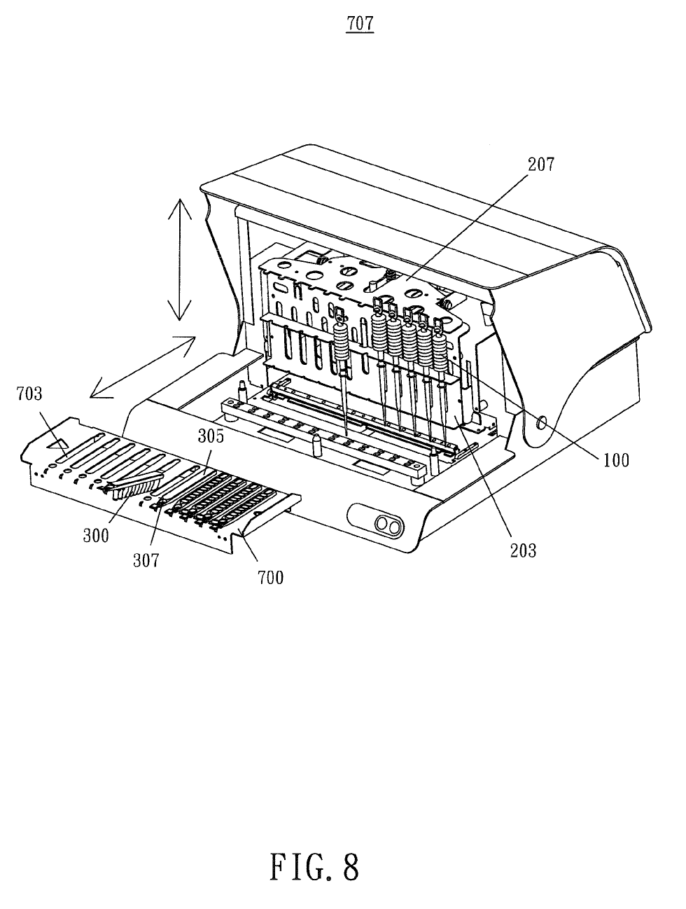

Referring to FIG. 8, to realize precise control for biochemical purification, extraction, selection and/or inspection, the pipette 100 of the present invention is capable to perform relative movement with respect to the tray 700 by means of the manipulator 203. Thus, the manipulator 203 and the tray 700 together form movement control means 707 for the liquid transfer device in accordance with the present invention. For example, the pipette 100 that is attached to the manipulator 203 provides or effects movements for horizontal displacement and/or vertical displacement, wile the tray 700 is kept stationary and the driving mechanism 207 is operated to effect release and/or suction of the test agents into/from the pipette 100; or alternatively, the pipette 100 that is attached to the manipulator 203 effects movement for horizontal displacement, while the tray 700 carries out movement for vertical displacement; or further alternatively, the pipette 100 that is attached to the manipulator 203 takes movement for vertical displacement, while the tray 700 performs horizontal displacement and again, the driving mechanism 207 is operated to effect release and/or suction of the test agents into/from the pipette 100 for processes of purification, extraction, selection, and/or inspection of nucleic acids.

Compared to the prior art techniques, the present invention provides a liquid transfer device and a pipette and an analysis container used in the liquid transfer device, wherein the pipette is a disposable tube having a sealed interior space that effectively alleviate cross contamination occurring in the course of liquid transfer. Further, the manufacturing of the disposable tube of the pipette overcomes the complicated process that is conventional adopted, but still maintaining the precision of the amount of the liquid being transferred. The present invention also provides an analysis container that is pre-fillable with biochemical agents and a tray, both being engageable with and thus retained to each other. Further, a tip portion is provided on the analysis container to facilitate removal of a cover film that seals the container to thereby eliminating any potential risk of deterioration of the result of purification, extraction, selection, and/or inspection of nucleic acids due to contamination of the test agents inside the container caused by contaminants attached to the surface of the cover film.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid transfer device comprising:
a pipette forming an interior space extending in an axial direction and having first and second ends, the first end forming an opening and the second end forming an enclosed variable volume, whereby variation of the volume causes change of pressure, which selectively induces a suction force or a releasing force in the pipette, the pipette further comprising at least one fixing section;
an analysis container forming a plurality of receptacles which is retained by a slab, the analysis container comprising a lock section;
cover means comprising a cover film that covers a surface of the slab to seal the analysis container; and
movement control means comprising a manipulator and a tray, the tray forming a cavity receiving the analysis container therein and a retention section engageable with the lock section to secure the analysis container to the tray.

2. The liquid transfer device as claimed in claim 1, wherein the second end of the pipette comprises an enclosed volume-variable bladder that defines the variable volume of the second end of the pipette, the bladder comprising a bellow structure made of an elastic material, and extending in an axial direction of the pipette or in a direction transverse to the axial direction.

3. The liquid transfer device as claimed in claim 1, wherein the second end of the pipette comprises an enclosed volume-variable bladder that defines the variable volume of the second end of the pipette, the bladder comprising an elastic structure having a spherical shape.

4. The liquid transfer device as claimed in claim 1, wherein the manipulator comprises at least one coupling member for engaging and retaining the fixing section of the pipette.

5. The liquid transfer device as claimed in claim 1, wherein the movement control means comprises a driving mechanism for inducing an action force to the pipette to cause the variation of the volume of second end of the pipette to selectively generate the suction force and the releasing force.

6. The liquid transfer device as claimed in claim 1, wherein the fixing section selectively comprises a groove, a circumferential slot, and a hole.

7. The liquid transfer device as claimed in claim 1, wherein the slab forms an opening in which an individual receptacle is received and held, the individual receptacle functioning as a final product collection receptacle and located at an end of the slab, the individual receptacle comprising a cover.

8. The liquid transfer device as claimed in claim 1, wherein the receptacles include a magnetic separation receptacle having a substantially flat bottom having a sloped surface for retaining magnetic beads that are disposed in the magnetic separation receptacle for carrying out magnetic separation operation.

9. The liquid transfer device as claimed in claim 1, wherein the receptacles include temperature-controlled receptacles for realizing temperature control for the liquid transfer device.

10. The liquid transfer device as claimed in claim 7, wherein the slab has a surface on which a tip portion is formed at a location close to the opening for the final product collection receptacle.

11. The liquid transfer device as claimed in claim 1, wherein the pipette and the tray carried by the movement control means are relatively movable with respect to each other so that a relatively movable relationship is formed therebetween, the relatively movable relationship being selected from one of a first relationship wherein the pipette is movable in both horizontal and vertical directions, while the tray is kept stationary, a second relationship wherein the pipette is moved in the horizontal direction, while the tray is movable in the vertical direction, or a third relationship wherein the pipette is movable in a vertical direction, while the tray is movable in the horizontal direction.

12. A pipette adapted to use in a liquid transfer device, comprising a hollow member extending in an axial direction and having first and second ends in the axial direction, the first end forming an opening, the second end forming an enclosed variable volume, whereby the variation of the volume causes change of pressure to selectively induce a suction force or a releasing force in the pipette, the pipette comprising at least one fixing section.

13. The pipette as claimed in claim 12, wherein the fixing section selectively comprises a groove, a circumferential slot, and a hole those adapted to engage an external component.

14. The pipette as claimed in claim 12, wherein the second end of the pipette comprises an enclosed volume-variable bladder that defines the variable volume of the second end of the pipette, the bladder comprising a bellow structure made of an elastic material, and extending in an axial direction of the pipette or in a direction transverse to the axial direction.

15. The pipette as claimed in claim 12, wherein the second end of the pipette comprises an enclosed volume-variable bladder that defines the variable volume of the second end of the pipette, the bladder comprising an elastic structure having a spherical shape.

16. A container for use in a liquid transfer device comprising a plurality of receptacles retained by a slab, the container further comprising a lock section, and cover means comprising a film covering a surface of the slab.

17. The container as claimed in claim 16, wherein the lock section is engageable a retention member formed in an external component to be secured to the external component.

18. The container as claimed in claim 16, wherein the slab forms an opening in which an individual receptacle is received and retained, the individual receptacle functioning as a final product collection receptacle and located at an end of the slab, the individual receptacle comprising a cover, and wherein the slab has a surface on which a tip portion is formed at a location close to the opening for the final product collection receptacle.

19. The container as claimed in claim 16, wherein the receptacles include a magnetic separation receptacle having a substantially flat bottom having a sloped surface for retaining magnetic beads that are disposed in the magnetic separation receptacle for carrying out magnetic separation operation.

20. The container as claimed in claim 16, wherein the receptacles include temperature-controlled receptacles for realizing temperature control for the liquid transfer device.
